(19) United States
(12) Patent Application Publication
(10) Pub. No.: US 2012/0325929 A1
(43) Pub. Date: Dec. 27, 2012

(54) AIRFLOW CONTROLLER

(76) Inventor: Andrew Landers, Bluff Point, NY (US)

(21) Appl. No.: 13/510,748

(22) PCT Filed: Nov. 23, 2010
(86) PCT No.: PCT/US2010/057714

§ 371 Date: Sep. 11, 2012

Related U.S. Application Data
(60) Provisional application No. 61/263,630, filed on Nov. 23, 2009.

(51) Int. Cl. A01M 7/00

(52) U.S. Cl. 239/78

(57) ABSTRACT

A novel airflow controller is hereby disclosed in a variety of embodiments illustratively including round-design and tower-design embodiments. In one illustrative embodiment, an airflow controller apparatus includes a blower chamber, at least one sprayer, and at least one diverter. The blower chamber is configured for providing an airstream. The at least one sprayer is positioned proximate to the blower chamber and defines a spray path leading from the sprayer along which the sprayer is configured to spray a fluid. The at least one diverter is movably positioned proximate to the blower chamber and movable across a range of positions between a first position and a second position. When the diverter is in the first position, at least a portion of the airstream is directed out of the blower chamber away from the spray path of the at least one sprayer, and when the diverter is in the second position, at least a portion of the airstream is directed out of the blower chamber toward the spray path of the sprayer.

### CROSS-REFERENCE TO RELATED APPLICATION

This application claims priority to the prior-filed provisional patent application with Ser. No. 61/263,630, entitles “Airflow controller”, filed Nov. 23, 2009, the entirety of which is incorporated by reference herein.

### STATEMENT REGARDING FEDERALLY FUNDED RESEARCH OR DEVELOPMENT

This invention was made with government support under grant number 2009-04225 under the Viticulture Consortium—East, grant number 1080196-219843 under the Specialty Crop Research Initiative (SCRI), and grant number NYG 621400 under the Federal Formula Funds, all awarded by the United States Department of Agriculture. The government has certain rights in the invention.

### FIELD

The present disclosure relates generally to agricultural sprayers, and more specifically to an airflow diverter for a pesticide sprayer.

### BACKGROUND

The application of pesticides has been of concern for many years, particularly methods of reducing drift and improving deposition. The majority of growers use traditional airblast sprayers with hollow cone nozzles. Traditional airblast sprayers direct the air from a single, axial flow fan, mounted directly behind the sprayer. Axial fans are designed to move large volumes of air at low pressures. Sprayer manufacturers apparently have conducted very little research into airflow characteristics to improve directed deposition from a traditional airblast design. Many growers choose not to replace mechanically reliable sprayers but are interested in modifications to direct air into the canopy.

Spray drift is an important and costly problem facing pesticide applicators. Drift results in damage to susceptible off-target crops, environmental contamination to watercourses, and an unintentionally reduced rate of application to the target crop, thus reducing the effectiveness of the pesticide. Pesticide drift also affects neighboring properties.

Current spray practice utilizes the same settings on the airblast sprayer for the entire growing season, from the first application to the last, irrespective of changes in canopy volume or density. A few growers may change the pesticide volume per hectare, but changes are seldom made to air flow (speed, volume or direction) or forward speed. As the season progresses and as the canopy fills, growers frequently drive too fast and often pay too little attention to deposition on the leaves and crops where disease or insects may occur.

Traditional airblast sprayers comprise a single, axial fan mounted directly behind the sprayer. The fan comprises an axial intake and radial outlet. The fan directs the air flow radially outwards in an upward and outward direction. Some growers may vary the pesticide liquid flow rate slightly as the season progresses but do not to alter the airflow. Some airblast canopy sprayers offer a two-speed, high/low gearbox on the fan drive system, but no sprayer on the market offers a variable airflow that may be adjusted while the sprayer is in motion. Other options available for directing spray towards the canopy are to attach adjustable covers to the top and base of the air outlet. The covers regulate the general direction of pesticide application to a small degree, but do not direct the pesticide to the target crop. Further, the covers backpressure the fan, causing strain on the fan motor.

### SUMMARY

A novel airflow controller is hereby disclosed in a variety of embodiments illustratively including round-design and tower-design embodiments. In one illustrative embodiment, an airflow controller apparatus includes a blower chamber, at least one sprayer, and at least one diverter. The blower chamber is configured for providing an airstream. The at least one sprayer is positioned proximate to the blower chamber and defines a spray path leading from the sprayer along which the sprayer is configured to spray a fluid. The at least one diverter is movably positioned proximate to the blower chamber and movable across a range of positions between a first position and a second position. When the diverter is in the first position, at least a portion of the airstream is directed out of the blower chamber away from the spray path of the at least one sprayer, and when the diverter is in the second position, at least a portion of the airstream is directed out of the blower chamber toward the spray path of the sprayer.

This Summary is intended only to provide a brief overview of subject matter disclosed herein according to one or more illustrative embodiments, and does not serve as a guide to interpreting the claims or to define or limit the scope of the invention, which is defined only by the appended claims.

### BRIEF DESCRIPTION OF THE DRAWINGS

For a further understanding of the objects of the various illustrative embodiments, reference will be made to the following detailed description which is to be read in connection with the accompanying drawings.

FIG. 1 depicts a perspective view of an airflow controller, in accordance with an illustrative embodiment.

FIG. 2 depicts a perspective view of diverters for an airflow controller, in accordance with an illustrative embodiment.

FIGS. 3, 4A, and 4B depict sectional side plan diagrams of part of an airflow controller including a diverter indicated in various illustrative positions, in accordance with an illustrative embodiment.

FIGS. 5-7 depict perspective views of an airflow controller including a diverter in different illustrative positions, in accordance with an illustrative embodiment.

FIG. 8 depicts a simplified perspective view of an airflow controller including a digital controller with a simplified block diagram of the digital controller, in accordance with an illustrative embodiment.

FIG. 9 depicts a sectional perspective view of an airflow controller, in accordance with an illustrative embodiment.

The drawings are not necessarily to scale, emphasis instead generally being placed upon illustrating the principles of various embodiments. In the drawings, like numerals are used to indicate like parts throughout the various views.

### DETAILED DESCRIPTION OF ILLUSTRATIVE EMBODIMENTS

In one embodiment, there is provided an airflow controller comprising a diverter. The diverter may be fitted to the air outlet of either round-design or tower-design canopy sprayers that are used to deliver pesticides to crops, such as fruit crops. The diverter may comprise an L-shaped cross-section, or a variety of other shapes in various embodiments. In one example, the diverter may be attached behind the airstream intake fan. In an illustrative embodiment, a first leg of the diverter may face into the airstream, that is, radially inward, while a second leg of the diverter may be positioned generally perpendicular to the fan outlet flow and/or generally parallel to or concentric with a fan side wall of the blower chamber. The first and second legs of the diverter may direct the air rearwards, away from the spray nozzles, when the diverter is in a first position, while the first leg of the diverter and a baffle may direct the air outwards toward the spray nozzles when the diverter is in a second position.

The diverter alters air output of the sprayer by adjusting the airflow using a slide device within the air outlet slot. In an illustrative embodiment, the diverter slides in an axial motion. The diverter may be freely adjusted along a continuum of positions in an axial direction to provide a large number of air flow settings. The diverter does not restrict airflow, but instead permits only the needed amount of air to move towards the crop canopy, while directing excess air to move to the rear of the unit away from the canopy. The diverter does not cause backpressure in the blower chamber or on the air flow system. The diverter may be manually or automatically adjusted, using an electronically operated actuator for example, to match the fruit canopy volume.

Aspects such as these are more particularly set forth in the figures and in the following descriptions thereof.

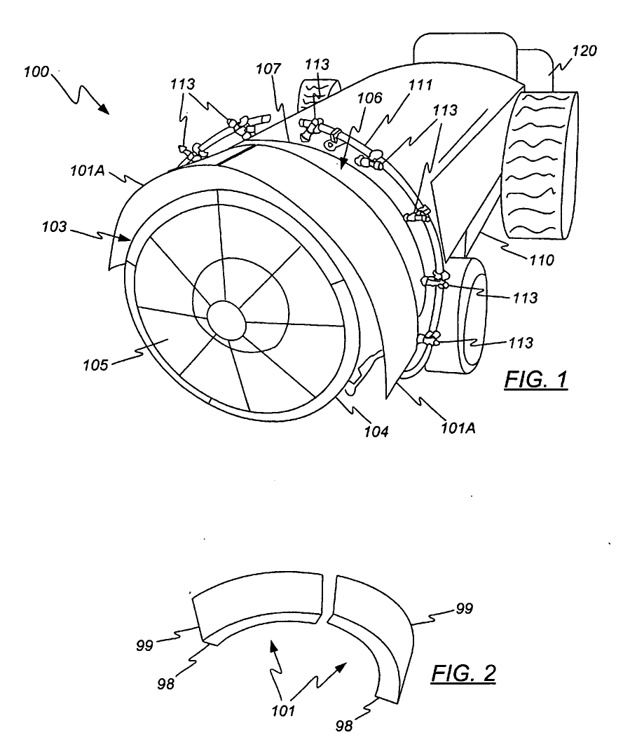

FIG. 1 depicts an airflow controller apparatus 100, in accordance with an illustrative embodiment. Airflow controller 100 includes blower chamber 103, a sprayer assembly 111 including a source pipe and multiple sprayers 113 mounted on tank 110, and two diverters 101A movably positioned proximate to blower chamber 103, in this illustrative embodiment. The distal end wall of tank 110 acts as a baffle 107 for the airstream provided by fan 105 having fan side wall 104, such that fan 105 and baffle 107 together may be considered to be included in a blower chamber 103, which also includes the chamber surrounding the fan 105 and which is configured for providing an airstream. An outlet between fan 105 and baffle 107 defines outlet slot 106 from which an airstream may escape from within blower chamber 103. Tank 110 acts as a mobile mounting apparatus on which sprayer assembly 111, blower chamber 103, and diverters 101A are disposed. Other embodiments may include only one sprayer or any number of sprayers, and only one diverter or any number of diverters, and any arrangement of blower chamber, as illustrative examples of different implementations encompassed by the present disclosure.

The sprayers 113 are positioned proximate to blower chamber 103 and each defines a spray path leading from the sprayer 113 along which the sprayer 113 is configured to spray a fluid. The diverters 101A are movable across a range of positions between a first position and a second position, where the first position may be a completely closed position and the second position may be a completely open position. Diverters 101A are depicted in the completely open position as disposed in FIG. 1. When the diverter is in the completely closed position, at least a portion of the airstream is directed out of blower chamber 103 away from the spray paths of sprayers 113, and when the diverter is in the completely open position, at least a portion of the airstream is directed out of blower chamber 103 toward the spray paths of sprayers 113. This portion of the airstream referred to here may illustratively include the entirety of the airstream, or a major portion that is not the entirety of the airstream due to possible other outlets elsewhere around blower chamber 103. For example, in the present illustrative embodiment, when the diverter is in the completely closed position, the entirety of the airstream in the general region of one of the diverters 101 may be directed out of blower chamber 103 away from the spray paths of sprayers 113, at the same time that other possible outlets around blower chamber 103 may allow some airstream to escape blower chamber 103 through those other outlets. Similarly, in the present illustrative embodiment, when the diverter is in the completely open position, the entirety of the airstream in the general region of one of the diverters 101 may be directed out of blower chamber 103 toward the spray paths of sprayers 113, at the same time that other possible outlets around blower chamber 103 may allow some airstream to escape blower chamber 103 through those other outlets.

FIG. 1 also depicts tractor 120, as an illustrative example of a vehicle that may be connected to tank 110 and which an operator may occupy while driving tractor 120 and controlling airflow controller 100.

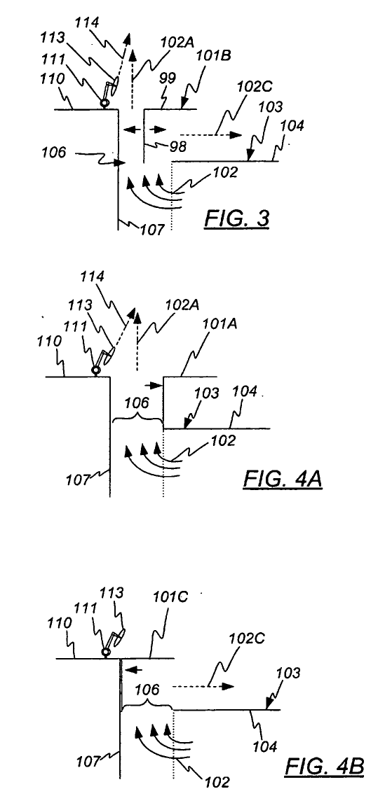

FIG. 2 depicts a perspective view of diverters 101 by themselves, identical to diverters 101A of FIG. 1. In the illustrative embodiment of FIGS. 1-7, diverters 101 are additionally labeled as 101A, 101B, or 101C to illustrate different positions in which the diverters 101 may be positioned on airflow controller 100, with 101A indicating diverters 100 in a fully open position, as in FIG. 1; 101B indicating diverters 100 in a partially open position; and 101C indicating diverters 100 in a fully closed position. This is further illustrated in the sectional side plan diagrams of FIGS. 3 and 4, in accordance with an illustrative embodiment. These aspects are further discussed as follows, in which diverters 101A, 101B, or 101C may also be referred to in general as diverters 101.

As shown in FIG. 2, each diverter 101 includes a first leg 98 and a second leg 99. When diverters 101 are positioned in airflow controller 100, as depicted in FIGS. 1, 3, and 4, first leg 98, which may be referred to as radial diverter leg 98, is oriented generally toward the blower chamber 103, and second leg 99, which may be referred to as axial diverter leg 99, is oriented generally sideways relative to the blower chamber 103 and away from the sprayers 113.

FIG. 3 and FIG. 6 depict diverter 101B in a partially open position. An airstream 102 is provided through outlet slot 106 out of blower chamber 103 and deflected by baffle 107. With diverter 101B in a partially open position, airstream 102 is intersected and divided by radial diverter leg 98 into two separate airstream portions 102A and 102C. Airstream portion 102A is guided between radial diverter leg 98 and baffle 107 to be emitted radially outward from outlet slot 106 and blower chamber 103, and toward sprayer 113 and the spray path 114 of sprayer 113; while airstream portion 102C is guided between radial diverter leg 98, axial diverter leg 99, and fan side wall 104 to be emitted axially outward from outlet slot 106 and blower chamber 103 and away from the direction of sprayer 113 and spray path 114.

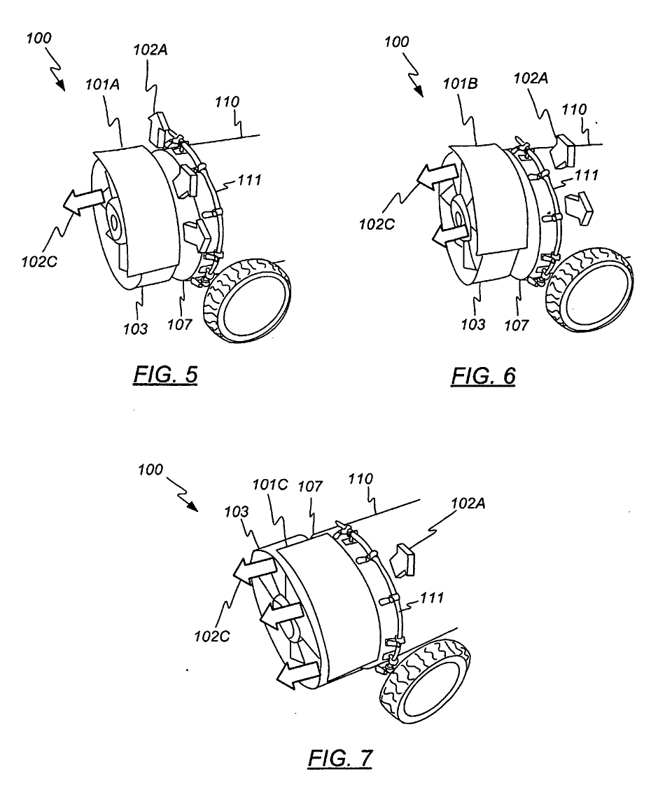

FIG. 4A depicts diverter 101A in a fully open position, in a sectional side plan view, while FIG. 4B depicts diverter 101C in a fully closed position, in a sectional side plan view. FIG. 5 also depicts diverter 101A in a fully open position in airflow controller 100 in a perspective view, while FIG. 7 also depicts diverter 101C in a fully closed position in airflow controller 100 in a perspective view. FIGS. 4A and 4B also more clearly depict outlet slot 106 defined between baffle 107 and fan sidewall 104 of blower chamber 103. When diverter 101C is in the fully closed position, the radial diverter leg 98 and the axial diverter leg 99 deflect the airstream 102 away from the spray path of the sprayer 113, as shown in FIG. 4B; and when the diverter 101A is in the fully open position, the axial diverter leg 99 is removed from a path of the airstream 102 and the airstream 102 is directed out of the blower chamber 103 between the radial diverter leg 98 and baffle 107 toward the spray path of the at least one sprayer 113, as shown in FIG. 4A. Diverter 101 is also positionable at any of variable positions between the fully closed position and the fully open position, in which the diverter divides the airstream from the blower chamber such that a variable portion of the airstream 102 is directed away from the spray path of the at least one sprayer 113 and a variable portion of the airstream 102 is directed toward from the spray path of the at least one sprayer 113, as represented by the embodiment shown in FIG. 3. As shown in FIGS. 5-7, all of the above apply to how the airstream 102 interacts with the spray paths of multiple sprayers on a sprayer assembly 111.

Various embodiments may also include a plurality of sprayers, and a plurality of diverters that are movably positioned proximate to the blower chamber and proximate to one or more respective sprayers that are proximate to that particular diverter. For example, FIG. 1 includes two separate diverters 101A, both of which are depicted as diverters 101 in FIG. 2. Each of the separate diverters in such an embodiment may be independently movably positioned proximate to the blower chamber 104. In this way, each of the diverters may be moveably positioned such that a portion of the airstream is directed out of the blower chamber away from the spray path of the respective sprayer and/or a portion of the airstream is directed out of the blower chamber toward the spray path of the respective sprayer.

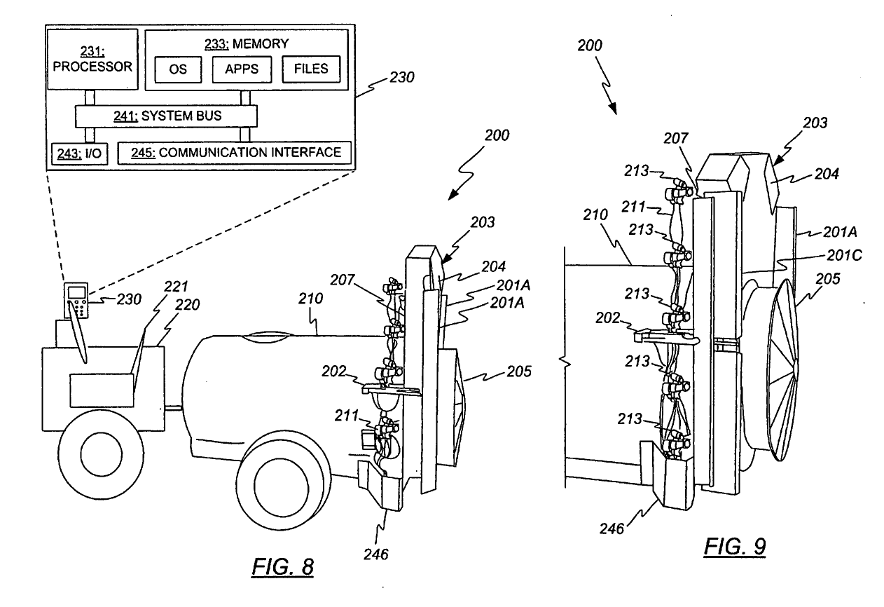

The airstream controller 100 of the illustrative embodiment of FIGS. 1, 2, and 5-7 may be referred to as a round-design type canopy sprayer, in which the blower chamber 103 has a generally round circumference, and the axial diverter leg 99, or axial section of the diverter 101, is curved to generally correspond to the fan wall 104 that forms the circumference of the blower chamber 103. FIGS. 8 and 9 depict a different embodiment corresponding to a tower-design type canopy sprayer, in which the blower chamber 203 comprises a straight side wall 204 extending to a height above a top of the intake fan 205, and an axial section of the at least one diverter 201 is planar to generally correspond to the straight side wall 204 of the blower chamber 203. FIG. 8 depicts two diverters 201A both positioned in a fully open position, while FIG. 9 depicts diverter 201C in a fully closed position and diverter 201A in a fully open position.

FIG. 8 also depicts airflow controller 200 including an electronic control 230, that can be used to provide signals for controlling the operation certain aspects of airflow controller 200 such as the movable positioning of diverter 201 between the open position 201A and the closed position 201C. Airflow controller 200 includes a vehicle 220 that includes an operator's section 221 configured for an operator to occupy while operating the vehicle and tank 210 that serves as a mobile mounting apparatus on which sprayer assemblies 211, blower chamber 203, and diverters 201 are disposed. Electronic control 230 is a mobile device that may be positioned in or proximate to the operator's section 221 as depicted in FIG. 8.

FIG. 8 also depicts an exploded sectional simplified block diagram of electronic control 230. Electronic control 230 includes one or more processors 231, one or more memory components 233, one or more input/output components 243, and one or more communication interfaces 245, interconnected such as by a system bus 241. The one or more memory components 233 may have stored on them any of one or more operating systems, one or more applications, and one or more files, potentially among other elements. Input/output components 243 may include components involved in a user input interface, such as keys and a screen, for example. The one or more communication interfaces 245 may include one or more wireless communication components that may communicate with one or more input sensors, and one or more control relays connected with an actuator 202, for example, where such input sensors and control relays are not explicitly depicted in FIG. 8 but may be housed within control box 246, for example.

The actuation means for diverters 101 of the embodiment of FIGS. 1-7 is positioned between diverters 101 and fan side wall 104 and thus obscured from view in FIGS. 1 and 4-7. FIGS. 8 and 9 more clearly depict actuator 202, which is mechanically connected to diverter 201 positioned at 201A in FIGS. 8 and 201C in FIG. 9, and which may be electrically connected to a control relay in control box 246. Diverters 101 of the embodiment of FIGS. 1-7 may be actuated by a similar actuator according to a variety of different embodiments.

An operator may thereby use electronic control 230 to enter inputs to directly control diverters 201 to position them between the fully open or fully closed position or anywhere in between. Electronic control 230 may also incorporate applications and files that support a fully automated control system, and may also receive inputs and outputs from other remote resources, such as through a wireless network connection with a network-administered application, for such purpose. Electronic control 230 may receive inputs from input sensors mounted on airflow controller 200 or from other sources and may incorporate such inputs into such an automated system.

Therefore, when the diverters 101/201 are positioned in a fully open position, the airstream is fully directed to mix with and aerosolize a liquid, illustratively such as a pesticide, that may be emitted in the spray path of the sprayers 113/213, and blow that aerosolized liquid over a broad area, such as across the canopy of nearby trees. The shape and form of the blown aerosolized airstream may be varied by opening or closing different diverters to different positions at different times, and by opening or closing different sprayers, and by choice of different sizes and shapes of airflow controllers, such as the lower, round airflow controller 100 and the taller, tower-design type airflow controller 200 depicted and described according to various embodiments herein. When the diverters 101/201 are in a fully closed position, the airstream is directed away from the spray paths of the sprayers 113/213 but is also still directed without obstruction out of the blower chamber 103/203, thereby preventing the buildup of backpressure in the blower chamber or on the air flow system, and preventing strain on a motor (not depicted) driving the fan 105/205, for example. The diverter may be manually or automatically adjusted, using an electronically operated actuator, for example, to match the fruit canopy volume, in accordance with a variety of embodiments. Various embodiments of airflow controllers encompassed by these inventive concepts may therefore administer airstreams and/or aerosolized fluids in a wide variety of configurations while preventing problems of blower chamber backpressure and preventing associated strains on mechanical parts, among other novel advantages.

While various embodiments have been particularly shown and described, it will be understood by those skilled in the art that various combinations of the disclosed elements or changes in detail may be made without departing from the scope of the claims. For example, the diverters or any section thereof, or any other component of an airflow controller, may be made out of any of a variety of materials, such as aluminum, steel, tin, plastic, or other materials, including of any type, grade, or alloy. As another example, any of a wide range of mechanical, electrical, or electronic control elements may be used, as well as communication means between a control element and the diverters and other components of an airflow controller. As yet another example, as an interpretive note, a leg of the diverter may be considered to be generally perpendicular or generally parallel to a reference element, such as the fan outlet flow or a baffle, in that if its extensional displacement is decomposed into components perpendicular to and parallel to the reference element, it is generally perpendicular to the reference element if its perpendicular component is greater than its parallel component, and it is generally parallel to the reference element if its parallel component is greater than its perpendicular component. Many variations may also be made within the realm of different embodiments, limited only by the scope of the claims as recited below.

What is claimed is:

1. An apparatus comprising:
a blower chamber, configured for providing an airstream;
at least one sprayer positioned proximate to the blower chamber and defining a spray path leading from the sprayer along which the sprayer is configured to spray a fluid; and
at least one diverter, movably positioned proximate to the blower chamber and movable across a range of positions between a first position and a second position, in which when the diverter is in the first position, at least a portion of the airstream is directed out of the blower chamber away from the spray path of the at least one sprayer, and when the diverter is in the second position, at least a portion of the airstream is directed out of the blower chamber toward the spray path of the at least one sprayer.

2. The apparatus of claim 1, in which the diverter comprises a first leg and a second leg, the first leg oriented generally toward the blower chamber and the second leg oriented generally sideways relative to the blower chamber and away from the at least one sprayer, such that when the diverter is in the first position the first leg and the second leg deflect air away from the spray path of the sprayer, and when the diverter is in the second position, the second leg is removed from a path of the airstream and the airstream is directed out of the blower chamber between the first leg and a baffle toward the spray path of the at least one sprayer.

3. The apparatus of claim 2, in which the diverter is further positionable at any of variable positions between the first position and the second position, in which the diverter divides the airstream from the blower chamber such that a variable portion of the airstream is directed away from the spray path of the at least one sprayer and a variable portion of the airstream is directed toward from the spray path of the at least one sprayer.

4. The apparatus of claim 1, further comprising a plurality of sprayers positioned proximate to the blower chamber and a plurality of diverters movably positioned proximate to the blower chamber and proximate to a respective sprayer from among the sprayers, in which each of the diverters is independently movably positioned proximate to the blower chamber, such that each of the diverters may be moveably positioned such that a portion of the airstream is directed out of the blower chamber away from the spray path of the respective sprayer and/or a portion of the airstream is directed out of the blower chamber toward the spray path of the respective sprayer.

5. The apparatus of claim 1, in which the blower chamber has a generally round circumference, and an axial section of the at least one diverter is curved to generally correspond to the circumference of the blower chamber.

6. The apparatus of claim 1, in which the blower chamber comprises a straight side wall extending to a height above a top of the intake fan, and an axial section of the at least one diverter is planar to generally correspond to the straight side wall of the blower chamber.

7. The apparatus of claim 1, in which the diverter is movably positioned between the first position and the second position in response to a signal from an electronic control.

8. The apparatus of claim 7, in which the electronic control comprises a user input interface configured for receiving user inputs for controlling the diverter to be moved between the first position and the second position.

9. The apparatus of claim 8, further comprising a vehicle comprising an operator's section and a mobile mounting apparatus, the operator's section configured for an operator to occupy while operating the vehicle, and in which the blower chamber is disposed on the mobile mounting apparatus, in which the user input interface is positioned in or proximate to the operator's section.

10. The apparatus of claim 7, in which the electronic control comprises an automated system comprising one or more input devices, a memory component storing executable instructions, an output component configured for providing the signal, and a processor configured to receive input from the one or more input devices, to execute the instructions, and to provide an output based on the input and the instructions to the output component such that the signal is based on the output from the processor.

11. An apparatus comprising:
a blower chamber comprising an intake fan and at least one outlet slot comprising a baffle;
at least one sprayer positioned proximate to the outlet slot and defining a spray path leading from the sprayer along which the sprayer is configured to spray a fluid; and
at least one diverter movably positioned proximate to the at least one outlet slot, the diverter comprising a radial leg and an axial leg, the radial leg oriented generally toward the at least one outlet slot and generally parallel to the baffle and the axial leg oriented generally perpendicular to the at least one outlet slot and away from the baffle, the diverter movable between a first position in which the radial leg is adjacent to the baffle and a second position in which the radial leg is spaced apart from the baffle.

12. The apparatus of claim 11, in which when the diverter is in the first position the diverter defines a first air flow path out of the blower chamber through a space defined between the radial leg and the outlet slot, away from the spray path of the sprayer, and when the diverter is in the second position the diverter defines a second air flow path out of the blower chamber through a space defined between the baffle and the axial leg, toward the spray path of the sprayer.

13. The apparatus of claim 12, in which the diverter is further positionable at any of variable positions between the first position and the second position, in which the diverter divides air flow from the outlet slot between the first air flow path and the second air flow path.

14. The apparatus of claim 11, further comprising at least a second outlet slot comprising a second baffle, at least a second sprayer positioned proximate to the second outlet slot, and at least a second diverter movably positioned proximate to the second outlet slot, in which the second diverter is independently movably positioned proximate to the second outlet slot, the second diverter comprising a radial leg and an axial leg, the radial leg oriented generally toward the second outlet slot and parallel to the second baffle and the axial leg oriented generally perpendicular to the second outlet slot and away from the second baffle, the second diverter movable between a first position in which the radial leg is adjacent to the second baffle and a second position in which the radial leg is spaced apart from the second baffle.

15. The apparatus of claim 11, in which the blower chamber has a generally round circumference, and the axial leg of the at least one diverter is curved to generally correspond to the circumference of the blower chamber.

16. The apparatus of claim 11, in which the blower chamber comprises a straight side wall extending to a height above a top of the intake fan, and the axial leg of the at least one diverter is planar to generally correspond to the straight side wall of the blower chamber.

17. The apparatus of claim 11, in which the diverter is movably positioned between the first position and the second position in response to a signal from an electronic control.

18. The apparatus of claim 17, in which the electronic control comprises a user input interface configured for receiving user inputs for controlling the diverter to be moved between the first position and the second position.

19. The apparatus of claim 18, further comprising a vehicle comprising an operator's section and a mobile mounting apparatus, the operator's section configured for an operator to occupy while operating the vehicle, and in which the blower chamber is disposed on the mobile mounting apparatus, in which the user input interface is positioned in or proximate to the operator's section.

20. The apparatus of claim 17, in which the electronic control comprises an automated system comprising one or more input devices, a memory component storing executable instructions, an output component configured for providing the signal, and a processor configured to receive input from the one or more input devices, to execute the instructions, and to provide an output based on the input and the instructions to the output component such that the signal is based on the output from the processor.
